(19) United States
(12) Patent Application Publication
(10) Pub. No.: US 2002/0032727 A1
(43) Pub. Date: Mar. 14, 2002

(54) System and method for enhancing load controlling in a clustered Web site

(75) Inventors: Daniel M. Dias, Mohegan Lake, NY (US); Eric Levy-Abegnoli, Nice (FR); Pascal Thubert, Vence (FR)

Correspondence Address: A. Bruce Clay, IBM Corporation, T81/503, PO Box 12195, Research Triangle Park, NC, 27709, US

(73) Assignee: International Business Machines Corporation, Armonk, NY

(21) Appl. No.: 09/925,353

(22) Filed: Aug. 9, 2001

(30) Foreign Application Priority Data
Sep. 8, 2000 (EP) 00480074.4

(51) Int. Cl. G06F 15/16

(52) U.S. Cl. 709/203; 709/217

(57) ABSTRACT

A Web site using HTTP and assumed to be comprised of a plurality of individual servers, including a Network Control Scheduler (NCS) is enhanced. Any individual server may issue instructions to NCS. They are passed to NCS in a NCS-control HTTP header which includes directives that must be obeyed. Directives fall in three categories, namely: flow-control directives, sharing directives and NCS-queuing directives. A filter which limits their scope of application may be optionally included.

### FIELD OF THE INVENTION

The present invention relates generally to the global Internet network and more particularly to those of the Internet servers of World Wide Web (WWW) sites organized as a cluster or group of servers forming a single entity.

### BACKGROUND OF THE INVENTION

The Internet has grown so rapidly over the past years that many companies, utilizing Web sites for their daily activities and as an efficient and attractive interface with their customers or users, are facing the problem of handling their own share of the explosive overall Internet traffic growth. If this growth is, however, not properly handled, users get slow response or refused connections, creating an unsatisfactory user experience which may be detrimental to the company owning such a Web site and may have catastrophic commercial impacts. Moreover, under critical load conditions, when too many requests for connection are received and/or because the service of the current requests is too demanding for the available computing resources of the site, the site can become unstable or even collapse. In order to prevent these problems from occurring, Web sites have been organized under the form of clusters of servers so scalability and full availability can be warranted through redundancy. Individual servers forming a cluster can thus be selectively replaced e.g., in case of failure and/or their number increased to cope, as needed, with a growing demand. This can be accomplished without any service interruption to the Web site, since only the affected individual servers need to be shut down while the others still serve users' requests. Load-balancing i.e., the ability to spread in a fair manner the overall workload over the active individual servers, was the key component to permit this to effectively happen. As an example, among other products commercially available, ND (Network Dispatcher), the load balancing component of WebSphere Performance Pack by IBM (International Business Machines Corp., Armonk, N.Y., the USA) has been developed to address these limitations and provide customers with advanced functions to meet their site's needs. A description of this particular product and the functions it provides can be found e.g., in ‘Load Balancing with IBM SecureWay Network Dispatcher’, published by ITSO (International Technical Support Organization) of IBM Corporation, Research Triangle Park, N.C., 27709, the USA, under reference SG24-5858. The early versions of Web traffic load balancers were simply performing round-robin, rotating the resolution of individual server names among a hard-coded list of IP addresses for Web application servers, balancing was hardly optimal since all user requests were considered as equal, and the actual availability of the individual servers and the workload on them was not taken into account; later issues of load balancing software included a more intelligent round-robin method along with a user-specified approach to distributing TCP/IP session requests. Thus, newer load balancing products, like ND, improve the performance of servers by basing their load balancing decision not only on the servers' availability, capability and workload, but also on many other new user-defined criteria as well. As a result of this greater flexibility, Web sites can now take advantage of differentiated qualities of service, based on request origin, request content and overall load on the system while the entire load balancing operation is transparent to end users and other applications. This is very useful for applications such as e-mail servers, World Wide Web (WWW) servers, distributed parallel database queries, and many other TCP/IP applications. When used with Web servers, it can help maximize the potential of a Web site by providing a powerful, flexible, and scalable solution to peak-demand problems. Thus, ND and other advanced load balancer products are able to balance the load on clusters of servers, servers within a local area network (LAN) or even over a wide area network (WAN) using a number of weights and measurements that are dynamically set by a dispatcher component which provides load balancing at the level of specific services, such as HTTP (Hyper Text Transport Protocol), FTP (File Transfer Protocol), SSL (Secure Sockets Layer) and Telnet (the virtual terminal protocol based on TCP/IP). Load balancing on servers within a local or wide area network can be performed using a DNS (Domain Name System) round-robin approach or a more advanced user-specified approach while client Web requests can also be directed to specified servers by comparing the content of the request to a predefined set of rules.

However, whichever level of sophistication the newer load-balancing functions have reached, they all still fail handling an important aspect of load balancing, namely, the lack of any provision for allowing applications running on the individual servers or on a users machine to pass feedback information to the load-balancing function so that this latter may react accordingly. A typical example of this is pacing. If an application, although running on a server which is far from being over utilized, cannot handle, by design or because of any other consideration, more than a given number of requests over a certain period of time, load-balancing should be informed so that it may pace the rate at which requests are forwarded to this particular application even though server resources are far from being fully exploited.

### SUMMARY OF THE INVENTION

A system and a method for enhancing load controlling of a Web site are disclosed. The Web site is assumed to comprise a plurality of individual servers, including a Network Control Scheduler (NCS). The Web site uses the Hyper Text Transport Protocol (HTTP). The invention allows any server, out of the plurality of individual servers, to issue instructions to the NCS to which this latter has to comply with. The instructions are passed to NCS in a NCS-control HTTP header including directives to be obeyed by NCS. Directives fall into three categories, namely: flow-control directives, sharing directives and NCS-queuing directives. They optionally include a filter which limits their scope of application.

Hence, the invention permits Web sites using HTTP and a cluster of servers in which application scheduling and control facilities become an integral part of load-balancing functions to achieve a better utilization of all site resources.

### BRIEF DESCRIPTION OF THE DRAWINGS

The foregoing features of this invention, as well as the invention itself, may be more fully understood from the following Detailed Description of the invention, of which:

FIG. 1 illustrates prior art.

FIG. 2 introduces the Network Control Scheduler (NCS) per the invention as part of a cluster servers.

FIG. 3 describes the directives to which NCS must obey.

FIG. 4 shows a scenario involving the share directive.

FIG. 5 shows a scenario involving the NCS-queuing directive (lock and unlock).

### DETAILED DESCRIPTION OF THE PREFERRED EMBODIMENT

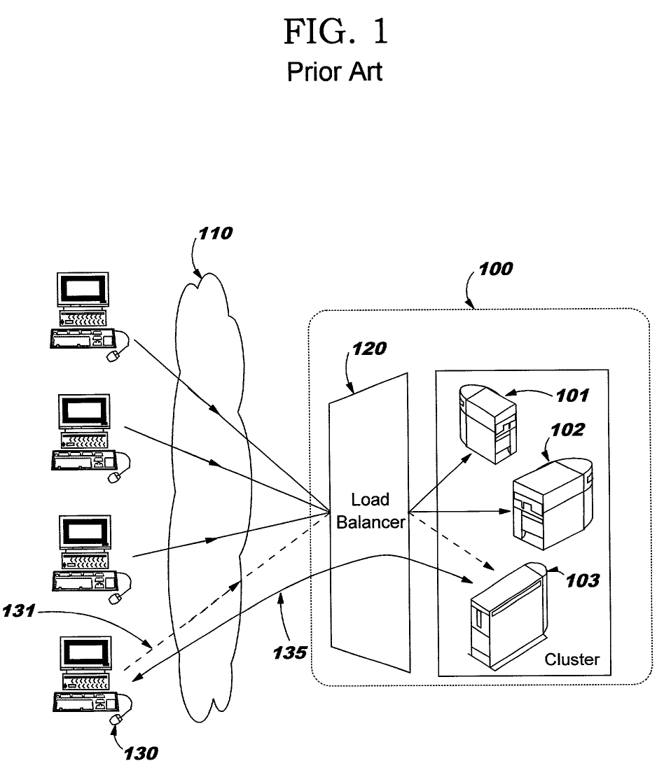

FIG. 1 illustrates a typical situation of the prior art for which the present invention may be applied to improve performance. A Web server 100 is implemented under the form of a cluster of individual servers 101, 102 and 103 which are fed from a load-balancer 120. The load-balancer 120 spreads the load generated from remote clients e.g., 130 which issue requests through a private and/or a public IP network 110 or any combination thereof. When an initial request 131 reaches the server 100 load balancer 120 must decide, on its own, based on what it knows of the current load over the individual servers, to have the initial request 131 served on an individual server e.g., 103. Thus, a session 135 is open between user 130 and the individual server 103. However, no further monitoring of subsequent user requests and responses, exchanged during the session, will be used to alter the exchange of information so as to dynamically better adapt to the actual behavior of either the particular user 130, the individual server 103 or the cluster of servers as a whole. However, it would be beneficial for the exchanges of data during a session such as 135 to be monitored and adjusted at the application level through the exchange of scheduling and pacing commands in order to obtain a better regulation of the flows resulting in a better utilization of the network and server resources.

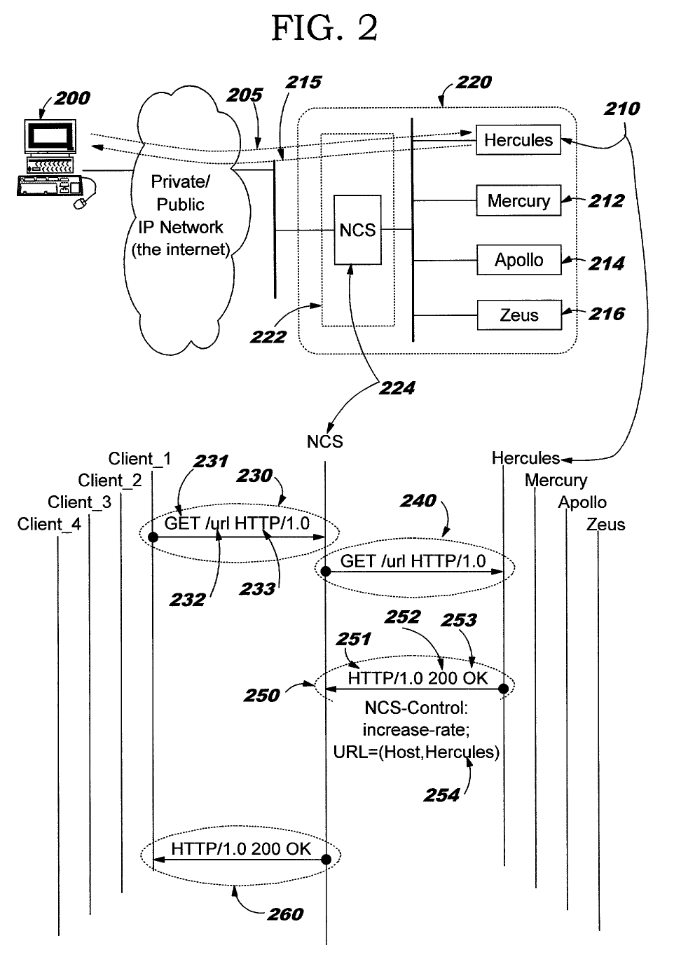

FIG. 2 HTTP (Hyper Text Transport Protocol) is the primary protocol used for transferring Web documents. It is a request/response protocol i.e., a client 200 sends a request 205 which ends up in a server e.g., 210, and the server sends back a response 215. There are no multiple-step handshakes in the beginning as with some other protocols. A server 220 is shown to be comprised of four individual servers 210, 212, 214, 216 and possibly equipped with a front-end load balancer 222 of the kind discussed in the Background section and in FIG. 1. However, the server 220 also includes a NCS (Network Control Scheduler) function 224 as per the invention. An HTTP request 230, forwarded 240 to the server 210 through NCS function 224, consists of a method e.g., the GET method 231, a target URL (Uniform Resource Locator) 232, a protocol version identifier 233, and a set of headers further discussed in the following. The method specifies the type of operation. The most common method, GET 231, is used to retrieve documents. Headers add additional information to the request and responses.

Much more on this can be found in the version 1.0 of HTTP protocol which is documented in the Informational RFC (Request For Comment) #1945 titled “Hypertext Transfer Protocol-HTTP/1.0.” of the IETF (Internet Engineering Task Force). HTTP in general is also discussed in numerous other publications such as in a book by Ari LUOTONEN, titled “Web Proxy Servers”, published by PRENTICE HALL, ISBN 0-13680612-0.

An HTTP response 250 consists of a protocol version identifier 251, a status code 252, a human-readable response status (OK) 253 and response headers 254 followed by the requested resource content (not shown), since the request was assumed to be a GET in this example. Headers are used to include additional information to both requests and responses. The version 1.1 of HTTP specification defines forty-six standard headers. An example of a general header (a general header can be found either in a request or in a response while there are specific request or response headers), is for example the “Cache-Control” header which is used to control various aspects of caching a key function to be supported in many proxies. In addition to the standard headers, new applications are allowed to have their own specific headers so HTTP can be easily extended. Therefore, the present invention assumes that a set of HTTP headers such as 254, aimed at enabling flow-control between clients and Web servers, are specified. The new HTTP header shown in this particular example is thus aimed at informing NCS 224 to increase its rate of requests when they are directed to the individual server 210 named ‘Hercules’. Hence, this server 210 can dynamically inform those using its resources that it can indeed, for the time being, process more requests than it has presently been asked. This information may be used by the NCS 224 and may not need to be included in the chained response 260 to the end-client. The syntax of the new HTTP headers of this example generally follow RFC (Request For Comment) 2616 of the IETF (Internet Engineering Task Force) specifying the version 1.1 of HTTP. Especially, RFC 2616 makes use of a so-called BNF (Backus-Naur) form of notation which is also occasionally utilized herein.

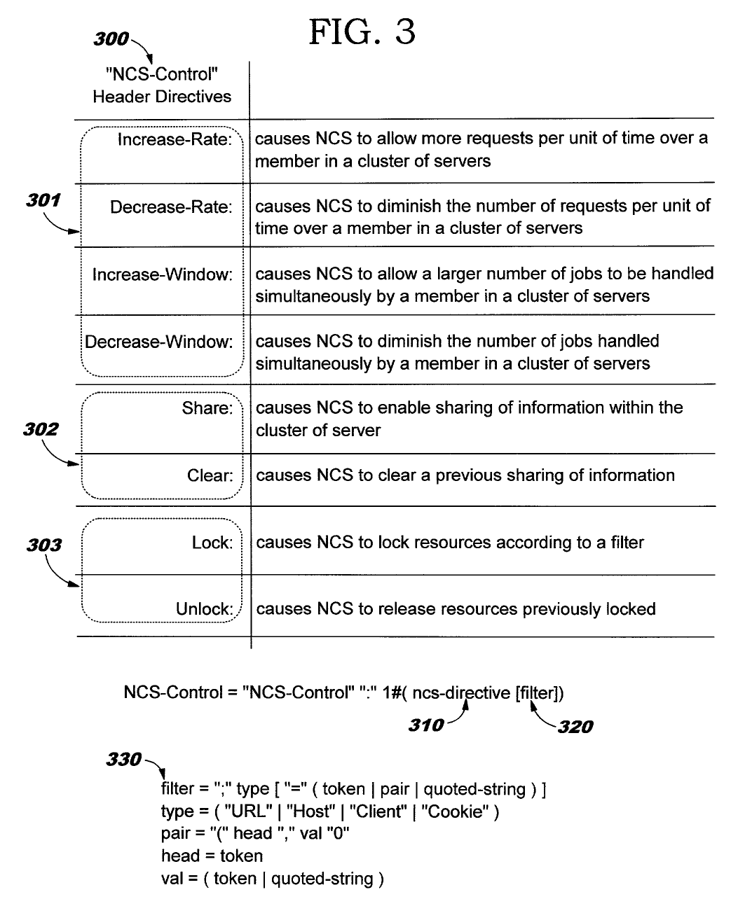

FIG. 3 shows the defined directives of a new HTTP header hereafter referred to as “NCS-Control” HTTP header 300 that must be obeyed by an NCS component. The overall intent of these directives is to extend the scope of the HTTP protocol replies to convey flow control information, as well as cluster level control and communication commands to an NCS function implemented as a front end to a cluster of servers. The new NCS-Control HTTP header 300 is comprised, in the general case, of a directive 310 and a filter 320 that limits the range of application of the directive, plus additional data when necessary. The filter operates on HTTP objects, such as the origin server, known by its DNS (Domain Name System) name IP address, the client, the HTTP headers, the cookies (described in RFC 2109), and the URL (Uniform Resource Locator). The filter syntax 330 includes a type, an object name and a string in the form of a regular expression that is to be matched with the occurrence of the HTTP object in the request. The default is ‘all’, meaning that the directive applies to all further requests. There are three types of filters i.e., URL, Cookie and Headers, depending on the object it operates on. Well known object names are added to represent the URL content: the locally significant part (URI), the web server (Host) and the client (Client).

A first group 301 of NCS-Control header directives deals with flow control. NCS function is then enabled to control the rate at which requests are passed to the cluster of servers expressed as a number of requests per unit of time e.g., per second. Also, the overall number of requests that are being served at any moment can be controlled by specifying a window setting for a number of requests that are allowed to be processed simultaneously. Hence, the present invention adds directives to increase and decrease both window and rate. Thus, directives are: “increase-rate”, “decrease-rate”, “increase-window”, and “decrease-window”. An example of this, also shown in FIG. 2 at reference numeral 254, is thus:

NCS-Control: increase-rate; URL=(Host, Hercules)

which causes NCS to allow more connections per second globally on the member of the cluster whose name is ‘Hercules’.

A second group of directives 302 enables the sharing of information among all members within a cluster of servers so they can all become aware of a situation or event regarding a member. To achieve this, HTTP is used as a communication means and the NCS function acts as a central communication device. Then, any member in the cluster is allowed to deposit an HTTP header in NCS. This latter is added to all subsequent requests issued from NCS that match a provided filter, until the HTTP header is cleared. The directives used to achieve this are “share” and “clear” of which an example is:

NCS-Control: share=(Username, Pascal); Cookie=(Session, 9098098)

Thus, “share” causes NCS to add an HTTP header e.g., ‘Username, Pascal’ in any subsequent request containing a cookie named ‘Session’ and having a value of ‘9098098’ while “clear” does the opposite i.e., removes.

A third group of directives 303 is devoted to queue management within NCS. Two directives of this category are “lock” and “unlock”. They are aimed at allowing NCS to control whether the service of a cluster resource, identified with a filter, can be performed immediately or should rather be delayed so that they are temporarily locked. An example of it being:

NCS-Control: lock; URL=(URI, “/appli/*”)

which causes NCS to lock all the resources of a particular application e.g., “/appli/” and where URI is the locally significant part of the URL. Either a time out or an unlock command can clear the lock.

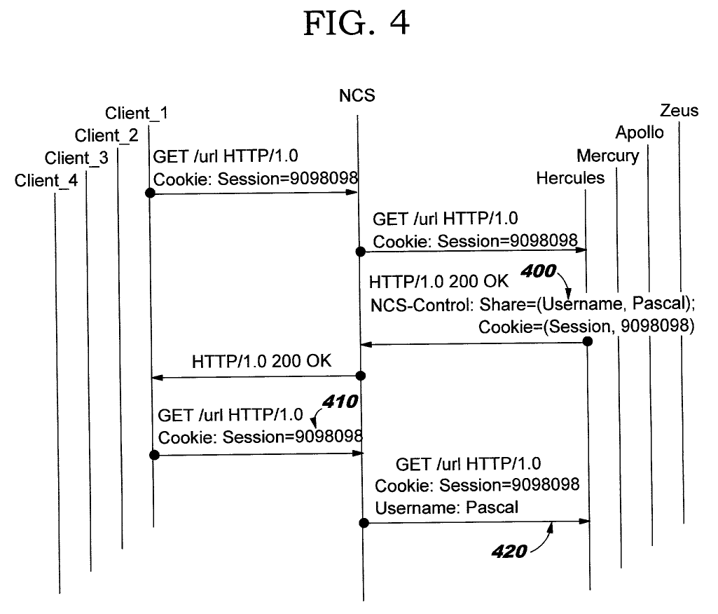

FIG. 4 further illustrates the second group of directives which deal with the sharing of information among the cluster members. As an example, an existing user session is identified with a cookie named ‘Session’ and having a value as identified by reference numeral 410 of ‘9098098’. Then the following command is issued:

NCS-Control: share=(Username, Pascal); Cookie=(session, 9098098)

Hercules instructs NCS 400 to add an HTTP header named ‘Username’ with a value of ‘Pascal’ to any subsequent request if a cookie named ‘session’ is present with the value 410 of ‘9098098’. In which case an application running on Mercury 420, or on any one of the individual servers of the cluster, can directly extract the user name from the HTTP flow without having to go to the session to do so. Later (not shown), upon issuing:

NCS-Control: clear=Username; Cookie=(session, 9098098)

Hercules commands NCS to undo the previous command with the same scope, at the time the session is removed by the application server.

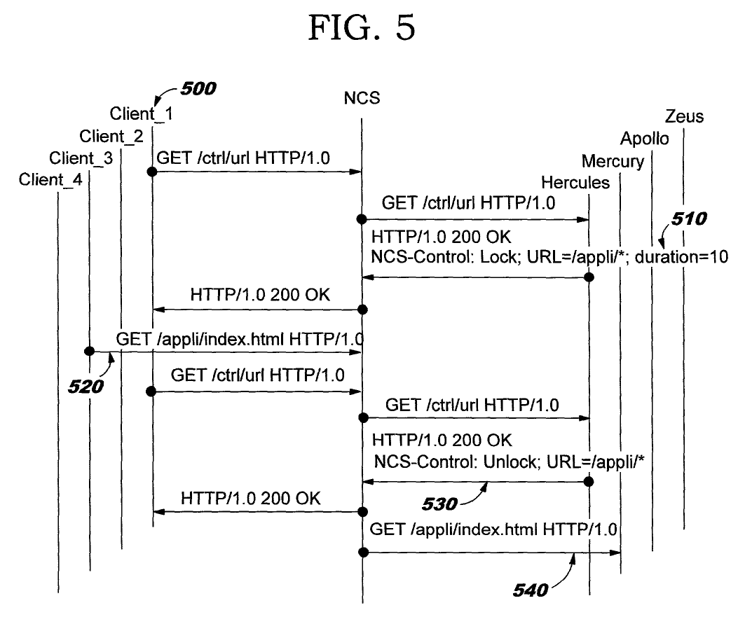

FIG. 5 illustrates the third group of directives which involve queue management within NCS. Upon receiving a request from a client 500 e.g., Client_1 to control URL, Hercules instructs NCS [510] to delay any further request to the WEB application path ‘/appli/’, issuing:

NCS-Control: lock; URL=(URI, “/appli/*”)

Hence, when a request from another client, e.g., Client_3 arrives later on as indicated by reference numeral 520 it is queued in NCS. When a condition is reached, Client_1 comes back to the control application and, as a result, Hercules may release the lock 530 by issuing:

NCS-Control: unlock; URL=(URI, “/appli/*”)

At that point, the request from Client_3 is passed to the cluster 540, and may be served by Mercury. This mechanism allows definition of fall back URLs in NCS so that when combined with the “lock” directive, the queued requests would be passed to a fall back service after a given period of time has elapsed.

What is claimed is:

1. A method for enhancing load controlling of a Web site including a plurality of individual servers and a Network Control Scheduler (NCS), said Web site using the Hyper Text Transport Protocol (HTTP), said method comprising the steps of:
in any one server out of said plurality of individual servers:
issuing instructions to said NCS;
receiving said instructions in said NCS from said any one server; and
complying with said received instructions.

2. The method of claim 1 wherein the step of issuing instructions includes the step of:
passing said instructions to said NCS in a NCS-control HTTP header, said passing step further including the steps of:
including directives to be obeyed by said NCS; and
optionally including a filter to limit the scope of application of said directive.

3. The method according to claim 2 wherein said directives includes:
flow-control directives;
sharing directives; and
NCS-queuing directives.

4. The method according to claim 3 wherein said flow-control directives include:
an increase-rate directive to require said NCS to increase the rate at which requests to said any one server are sent;
a decrease-rate directive to require said NCS to decrease the rate at which requests to said any one server are sent;
an increase-window directive to require said NCS to increase the number of jobs allowed to be simultaneously processed in said any one server; and
a decrease-window directive to require said NCS to decrease the number of jobs allowed to be simultaneously processed in said any one server.

5. The method according to claim 4 wherein said sharing directives include:
a share directive aimed at enabling an information sharing within all members of said plurality of individual servers and said NCS; and
a clear directive aimed at clearing a previous said information sharing.

6. The method according to claim 5 wherein said NCS-queuing directives include:
a lock directive aimed at locking resources identified by said filter; and an unlock directive aimed at releasing previously locked said resources.

7. A system, in particular a Network Control Scheduler comprising means adapted for carrying out the method according to claim 6.

8. A computer readable medium comprising instructions for carrying out the method according to claim 7.
